(19) United States
(12) Patent Application Publication
(10) Pub. No.: US 2025/0381475 A1
(43) Pub. Date: Dec. 18, 2025

(54) CLOUD CONNECTION WITH CELLPHONES TO VIRTUAL CPU/GPU

(71) Applicant: AT&T Intellectual Property I, L.P., Atlanta, GA (US)

(72) Inventors: Ambroise Asselin, Dallas, TX (US); Dylan Linstedt, Los Angeles, CA (US); Ninad Mali, Dallas, TX (US); Sheheryar Gaziani, Garland, TX (US); Kalyn Bentley, Dallas, TX (US)

(73) Assignee: AT&T Intellectual Property I, L.P., Atlanta, GA (US)

(21) Appl. No.: 18/745,217

(22) Filed: Jun. 17, 2024

(51) Int. Cl. A63F 13/355; A63F 13/358; G06T 1/20; H04M 1/72427

(52) U.S. Cl. CPC A63F 13/355; A63F 13/358; G06T 1/20; H04M 1/72427; G06T 2200/24

(57) ABSTRACT

Aspects of the subject disclosure may include, for example, A smartphone including a communication circuit for wireless communication with a mobility network and a processing system including a processor, along with a memory that stores executable instructions that, when executed by the processing system, facilitate performance of operations, the operations including requesting access over the mobility network to a remote application, and interacting with virtual processing components to process data of the remote application, wherein the virtual processing components are assigned to the smartphone for processing the data of the remote application. Other embodiments are disclosed.

### FIELD OF THE DISCLOSURE

The subject disclosure relates to a system and method for cloud connection of user devices such as cellphones to a virtual central processing unit, graphics processing unit and cloud storage to enhance operational capabilities of the user devices.

### BACKGROUND

Applications that run on user devices are requiring increased processing power and memory storage space. This has been addressed by increasing the physical size of user devices such as cell phones to accommodate more processors, more memory and larger batteries to power the user devices.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a system functioning within the communication network of FIG. 1 in accordance with various aspects described herein.

FIG. 2C is a block diagram illustrating an example, non-limiting embodiment of a conventional system for processing traffic between an end user and a remote application.

FIG. 2D is a block diagram illustrating an example, non-limiting embodiment of a conventional system for processing traffic between an end user and a remote application.

FIG. 2E is a block diagram illustrating an example, non-limiting embodiment of a system functioning within the communication network of FIG. 1 in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for using a network provider's network edge for decentralization of consumer device central processing unit (CPU) and graphics processing unit (GPU) to enable more efficient computing at the end device. Other embodiments are described in the subject disclosure.

One or more aspects of the subject disclosure include a smartphone including a communication circuit for wireless communication with a mobility network and a processing system including a processor, along with a memory that stores executable instructions that, when executed by the processing system, facilitate performance of operations. The operations may include requesting access over the mobility network to a remote application, and interacting with virtual processing components to process data of the remote application, wherein the virtual processing components are assigned to the smartphone for processing the data of the remote application.

One or more aspects of the subject disclosure include communicating, by a user device, with a mobility network operated by a network operator, requesting, over the mobility network, access to a remote application, communicating, over the mobility network, with an edge network of the network operator, and interacting, over the mobility network with the remote application, wherein the interacting with the remote application comprises interacting with a virtual graphics processing unit, a virtual processing unit, or virtual storage, or a combination of these, which have been temporarily established at the edge network to enable decentralized processing of data of the remote application.

One or more aspects of the subject disclosure include communicating, by a communication interface of a handheld user device, with a mobility network of a network operator, requesting, by a processing system of the user device, the processing system including a processor, access to a remote application located at a remote server; and communicating, by the processing system, over the mobility network with an edge network of the network operator, wherein the edge network accesses virtual processing components to process data of the remote application at the virtual processing components, wherein the virtual processing components are located geographically close to the edge network of the network operator to enable decentralizing of access to the remote application from the processing system of the handheld user device to the virtual processing components to improve user experience with the remote application at the handheld user device.

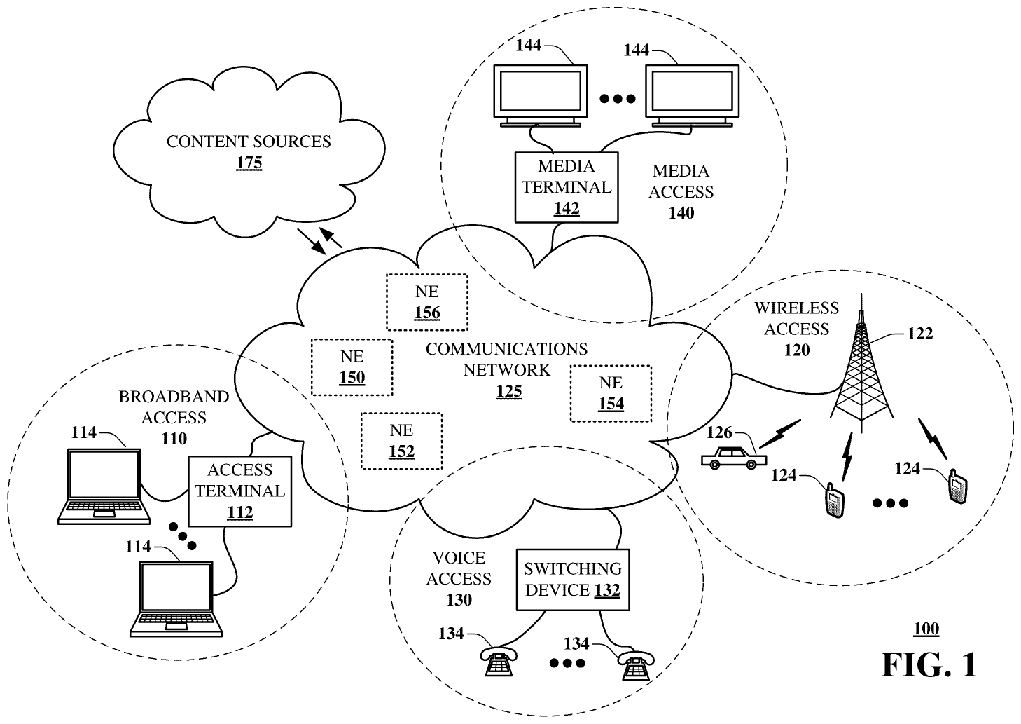

Referring now to FIG. 1, a block diagram is shown illustrating an example, non-limiting embodiment of a system 100 in accordance with various aspects described herein. For example, system 100 can facilitate in whole or in part <tie to a few of the main features of the claims>. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

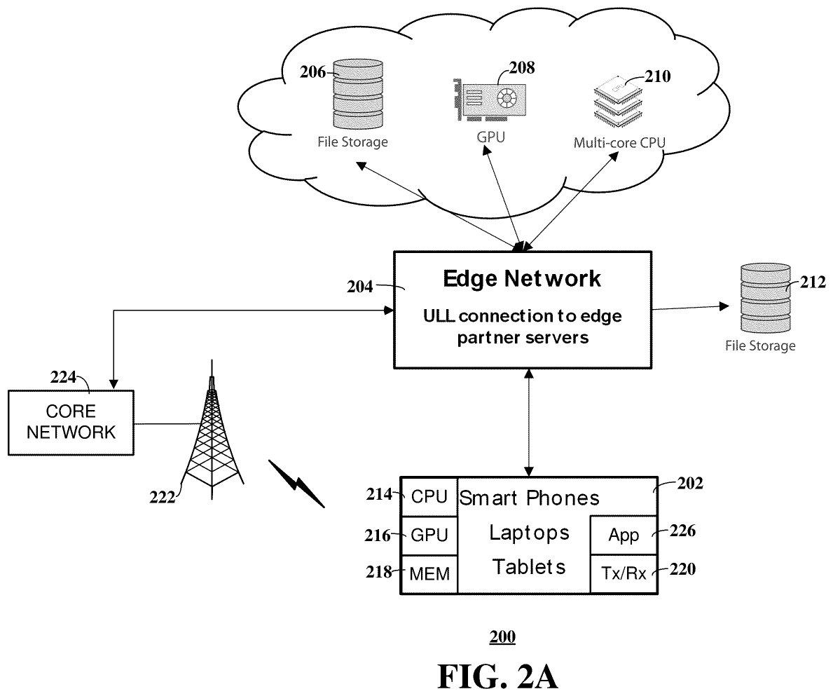

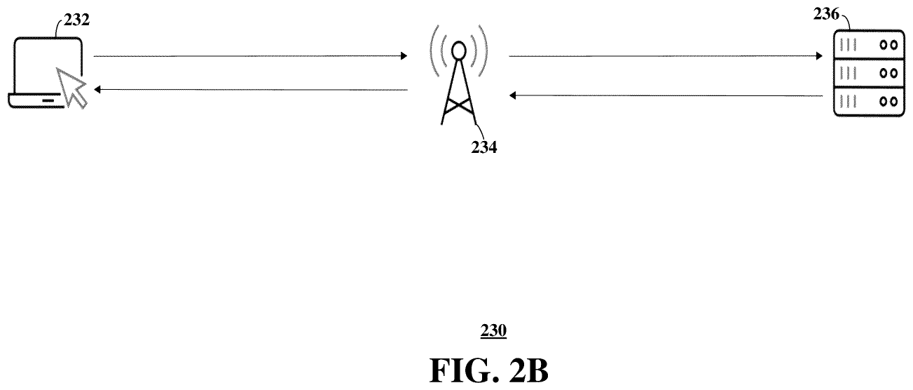

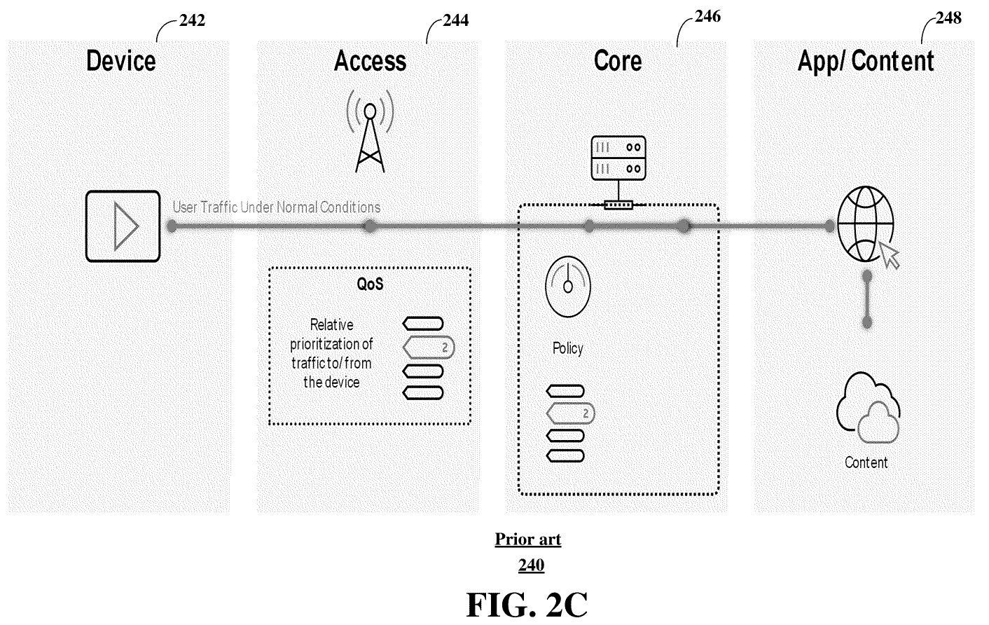

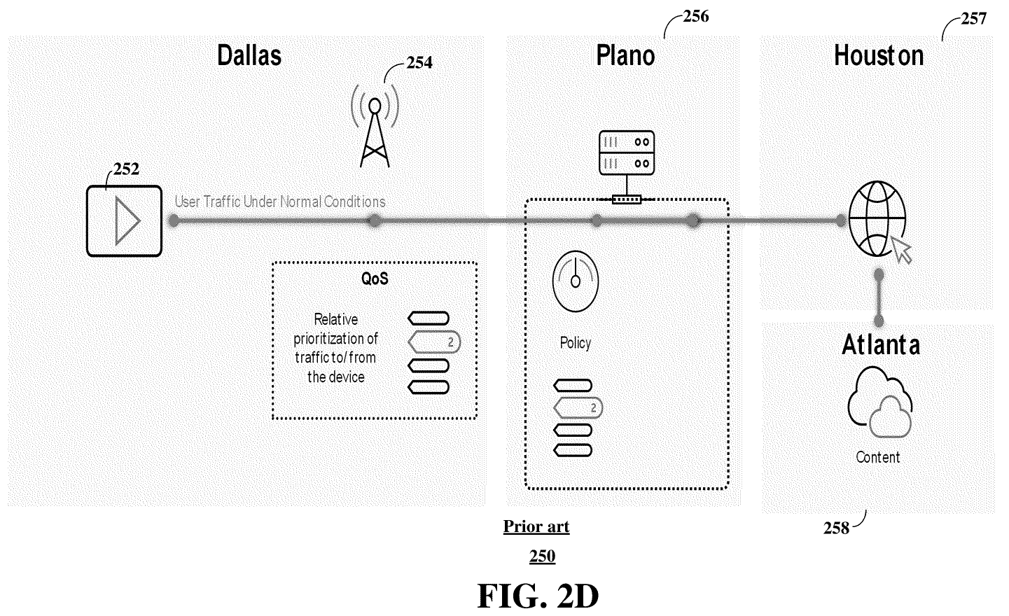

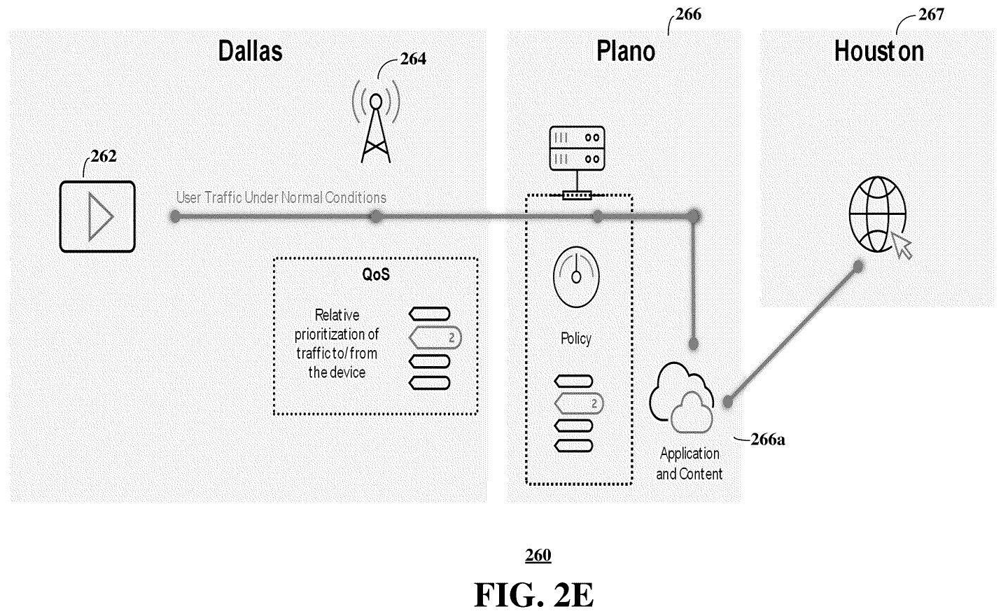

FIG. 2A is a block diagram illustrating an example, non-limiting embodiment of a system 200 functioning within the communications network 125 of FIG. 1 in accordance with various aspects described herein. The system 200 includes a user device 202 which accesses an edge network 204 of a network provider. In this example, the edge network 204 includes or is in communication with a virtual storage 206, a virtual graphics processing unit (VGPU) 208 and a virtual central processing unit (VCPU) 210. In additional the edge network 204 includes or is in data communication with a file storage system 212. Other embodiments may include additional or alternative devices or function differently from the exemplary embodiment of FIG. 2A.

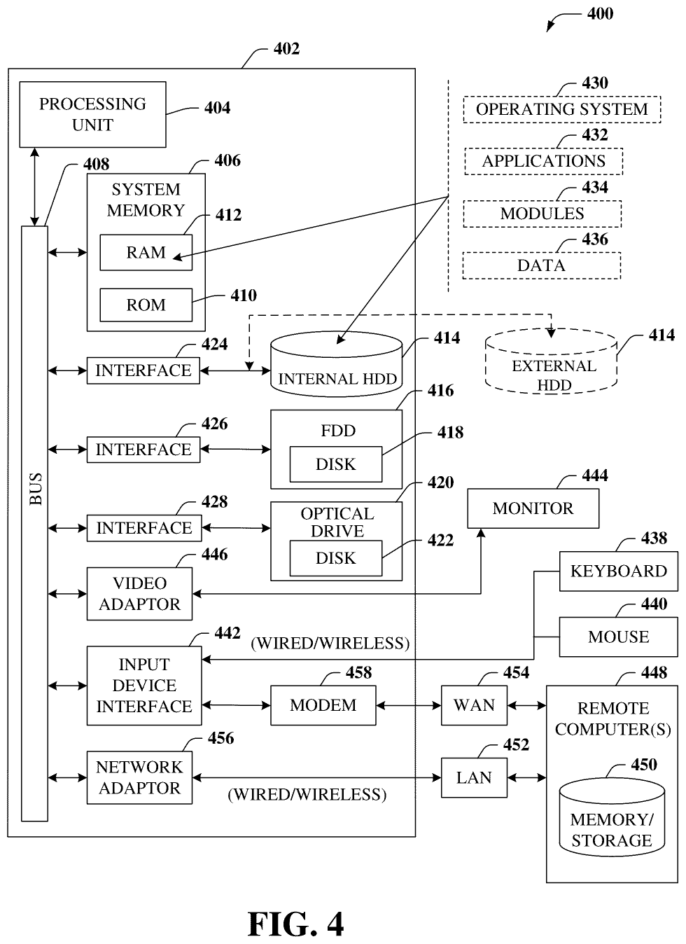

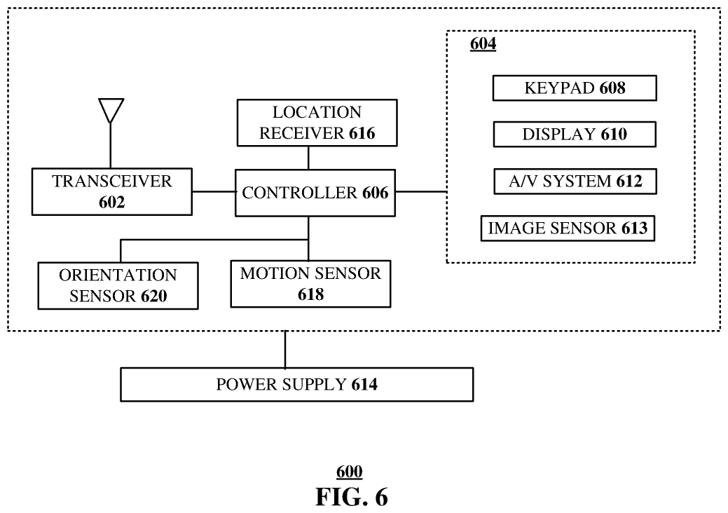

The user device 202 may include one or more devices such as a cellphone, a mobile phone, a laptop computer, a desktop computer, a tablet computer, an internet of things (IoT) device or any other data processing system. In some embodiments, the user device may incorporate features of a communication device such as communication device 600 described below in conjunction with FIG. 6. Moreover, the user device may incorporate features of a computing environment such as computing environment 400 described below in conjunction with FIG. 4.

In the illustrated example, the user device 202 includes operational circuitry including a central processing unit (CPU) 214, a graphics processing unit (GPU) 216, memory 218, communication circuitry 220 and one or more apps such as app 226. The CPU 214 is a processing system that may include one or more processors which respond to data and instructions for controlling operation of the user device 202. The CPU may operate in conjunction with one or more applications programs such as app 226. The GPU 216 is a specialized processing system optimized to perform operations such as complex mathematical calculations very quickly. For example, the GPU 216 may be designed to handle tasks that involve large amounts of data and repetitive calculations such as rendering graphics on a display of the user device, machine learning and video editing. The GPU 216 may operate more efficiently than the more general-purpose CPU for some data processing tasks. In some examples, the CPU will offload certain tasks, such as rendering graphics or processing streaming video or audio files, to the GPU. The memory 218 stores data and instructions and generally comprises semiconductor memory. The communication circuitry 220 may include a radio frequency (RF) front end for radio communication on one or more radio networks. In particular embodiments, the communication circuitry 220 includes a transceiver and associated circuitry for radio communication on a cellular network such as a fifth generation (5G) cellular network. Other wireless standards, as well as wireline communications, may be supported by the communication circuitry 220.

The user device 202 may include other features such as a user interface including a display, keypad, speaker and microphone. Further, the user device 202 may include a battery or other depletable energy source such as a capacitor for powering the user device 202. The applications, such as app 226, may operate with devices independent of the user device 202 such as web sites or gaming sites or other network locations accessed over a network.

The user device 202 may communicate in accordance with an air interface standard such as the 5G cellular standards published by the 3^{rd} Generation Partnership Project. Communication may be with one or more cellular base stations such as base station 222, also referred to as an eNodeb or eNB or a gNodeB or gNB. The base station 222 may be part of a mobility network operated by a network operator. The base station 222 may provide communication access to other network elements operated by the network operator such as a core network 224 and an edge network such as the edge network 204. The core network 224 provides network services such as mobility management, accounting and authorization management, and a gateway to other networks such as the public internet.

The edge network 204 corresponds to a local instance of a distributed computing network that brings computation and data storage closer to the sources of data, such as the user device 202. The edge network 204 brings computing physically closer to the user device 202 so as to reduce network latency compared to applications running at a remote data center. The edge network 204 operates to deliver quick responses close to where requests are made, such as the user device 202, particularly for applications needing immediate data processing. The edge network 204 may use virtualization to deploy and manage applications on edge servers of the edge network.

The edge network 204 may be accessed by the user device through the core network 224 or directly from the base station 222 or another network element. The edge network 204 in some embodiments may implement an ultra-low latency (ULL) network or network features. Latency corresponds to the time required to send data or a packet of data between a source and a destination. For example, 5G standards provide for low latency communications in which latency can be as low as 1 millisecond (ms). The ULL aspects of the edge network cooperate with low latency operation of the 5G wireless network to provide ultra-low latency communications with the user device 202.

As indicated in FIG. 2A, the edge network 204 provides data communication to one or more edge partner servers. Examples of the edge partner servers include the virtual storage 206, the virtual graphics processing unit VGPU 208 and the VCPU 210. In embodiments, the VGPU 208 and the VCPU 210 may be provided by or operated by a third-party service provider, i.e., a service provider independent of the network operator of the mobility network. For example, a user associated with the user device 202 or associated with the network operator may have a service agreement to access computing and data storage facilities of the third-party service provider. The third-party service provider may provide computing facilities on-demand from the user device 202 or from the edge network 204. In response to a request for services, the third-party service provider may spin up processing facilities such as the VGPU 208 or the VCPU 210 or the virtual storage 206, or some combination of these, to provide computing services or capacity for the user device. In some embodiments, the VGPU 208 and the VCPU 210 may be accessible at a number of performance levels. For a specified subscription fee or other compensation, the user of the user device 202 may access a specified performance tier. For the highest fee, the user may access the highest level of service which may be the highest-performance video graphics card available as the VGPU 208 or the largest number of CPU cores.

Similar to the CPU 214 and the GPU 216 of the user device 202, the VCPU 210 may be part of a processing system that may include one or more processors which respond to data and instructions for controlling operation of the user device 202. The processors may be configured as processor cores and a user of the user device may specify how many processor cores of the VCPU 210 should be selected to participate with the CPU 214 of the user device 202. The VCPU 210 and the CPU 214 may cooperate in conjunction with one or more applications programs such as app 226 as well as applications located remotely, such as on a remote network accessible over the public internet.

The VGPU 208 comprises a processing system optimized to perform operations such as complex mathematical calculations very quickly. For example, the VGPU 208 may be designed to handle tasks that involve large amounts of data and repetitive calculations such as rendering graphics on a display of the user device, machine learning and video editing. The VGPU 208 may operate more efficiently than a general-purpose CPU such as the VCPU 210 or the CPU 214 of the user device 202. for some data processing tasks.

In embodiments, the CPU 214 of the user device 202 and/or the VCPU 210 may selectively activate and cooperate with the VGPU where such cooperation may be helpful to increase processing of a particular task, such as downloading a streaming data file or editing a sound or video file. Processing capabilities of the VCPU 210 and the VGPU 208 may be selectively combined with capabilities of the CPU 214 and the GPU 216 as required to selectively increase processing capacity available to the user device 202. Similarly, the virtual storage 206 may be selectively accessed and added to the memory space available to the user device to selectively handle large-scale tasks, as required.

In this manner, processing on the user device 202 may be decentralized. The processing functions of the CPU 214, the GPU 216 and the memory 218 of the user device 202 may be combined or shared with or allocated to the VCPU 210, the VGPU 208 and the virtual storage 206. In embodiments, the user device 202 communicates over the ULL connection of the edge network 204 with the processing devices and memory, including the VCPU 210, the VGPU 208 and the virtual storage 206, which may be located in the cloud. As a result, the user device appears to operate in near-real-time with the added processing power of the VCPU 210, the VGPU 208 and the virtual storage 206. Moreover, the user of the user device 202 may select a number of processors to use so that the added processing power capacity and storage capacity may scale selectively with the size of a task to be completed on the user device. This may be enabled, for example, by an application such as application 226 operating on and accessible on the user device 202. For example, the user can interact with the app 226 on the user device 202 to specify a requested number of GPU cores provided by the VGPU 208 or a requested number of CPU cores provided by the VCPU 210, or a requested number of gigabytes of added memory from the virtual storage. The VCPU 210, the VGPU 208 and the virtual storage 206 can supplement the capabilities of the devices on the user device 202.

Thus, processing on the user device 202 can be decentralized to processing systems and memory systems having a much higher capacity than the user device 202 has alone. The operation of the user device 202 is decentralized to operate on supplemental devices. The edge network 204 links the user device 202 to the VCPU 210 and VGPU 208 provided by third-party service providers. Use of the

The user may make use of the high-performance capabilities of the VCPU 210, the VGPU 208 and the virtual storage 206 for any suitable type of work such as video editing or audio editing or computer aided design. Alternatively, the user may access the supplemental processing power and storage for other activities such as gaming, processing and downloading a large video file, participating in a virtual reality (VR) or augmented reality (AR) environment. Such activities require substantial processing power and memory capacity that may not be available on a typical user device such as a smartphone or tablet computer.

In further embodiments, the system 200 provides portability for the user who requires substantial computational power on the go or in different locations. The user may begin a project, such as an AR interaction, using a laptop computer in a lab. The user may then transfer the project to a portable device such as a smartphone and continue involvement with the AR interaction. While the smartphone may not have the native processing speed and memory size to handle the AR environment, since the processing and storage are decentralized through the edge network 204 to the VGPU 208, the VCPU 210 and the virtual file storage 206, the user's project can continue uninterrupted. The features of the mobility network including the base station 222 and the core network 224 enable an ultra-low latency connection for the user as the user travels with the smartphone. The user device 202 may be embodied as the laptop computer, the smartphone and other devices required by the user or available to the user. The requisite processing power and storage capacity are provided through the edge network 204 by the VGPU 208, the VCPU 210 and the virtual file storage 206.

In a further embodiment, the network operator associated with the mobility network and the edge network may provide cloud storage services via file storage system 212. Storage is accessible through the edge network 204 and may be selected and accessed, for example, using an app such as the app 226 on the user device.

A first use case for the system 200 enables more efficient involvement by a user and the user device 202 in cloud gaming. Cloud gaming may also be referred to as gaming on demand or game streaming. Cloud gaming is a service that allows users to play video games remotely on compatible devices by streaming the game from remote servers in data centers over the internet. This method of gaming is different from traditional gaming which involves running a game application locally on a user's device such as a gaming console.

In the example of cloud gaming, the user associated with user device 202 may take the game along from a fixed device to a portable device such as a smartphone or tablet computer. The decentralization feature described for the system 200 allows the user device 202 embodied as a smartphone or tablet to have substantially the same computational capability as a dedicated gaming console, for example. Conventionally, such large-scale games may be played on a device such as a smartphone. However, the processing requirements and memory requirements of the game are not well-matched to the smartphone hardware so that playing the game will rapidly deplete the battery or other depletable energy source that powers the smartphone. Moreover, the multitasking ability of the smartphone will be limited. A very large percentage of available processing power of the smartphone will be dedicated to game play and few other applications may be run in the background.

In contrast, using the decentralized arrangement described in conjunction with FIG. 2A allows the CPU 214 and GPU 216 of the smartphone to offload a substantial amount of the processing of graphics and other gaming functions to the VCPU 210 and the VGPU 208. The VCPU 210 and the VGPU 208 can interact with the remote server in the data center for ongoing game play and data transfer over a low latency connection. The use of the ultra-low latency connection between the smartphone and the edge network 204 to access the VCPU 210 and the VGPU 208 allows the user to interact with the gaming in near real time, with little or no noticeable delay in game play.

A second use case for the system 200 enables access to and management of very large amounts of data, particularly to a mobile device such as a smartphone or tablet. For example, in the case of a smart city or a smart factory, a large number of sensors are used to collect data from the environment or equipment in the environment. The data may be used to manage assets, resources and services efficiently. For example, individual assets or equipment may report, over a network, information about their respective maintenance status. The reported information may correspond to a large amount of data. Processing the data, such as for displaying the data, aggregating and organizing the data, etc., may require substantial processing power and a large memory space. The decentralized architecture exemplified by system 200 of FIG. 2A allows the user device 202 to collect such data and to cooperate with the VCPU 210, the VGPU 208 and the virtual storage 206 to supplement the processing capabilities of the user device 202. The processing and data storage may be moved off the device to the edge network 204 and to a close, local processing arrangement. The data does not need to be stored in a remote database many miles or thousands of miles away. The virtual CPU, virtual GPU and virtual storage can be instantiated as needed, on demand, while the project is underway.

In a third use case, an organization provides to its associates user devices such as the user device 202. However, the provided user devices are relatively low powered in terms of available memory and computational power. For example, the user devices may include a processor for managing the user interface, a processor for managing communication, and a single-core processor for some limited, additional, on-board processing. The associates may be employees at a job site, students at an educational institution, or any persons engaged in a specified function. The user devices may have enough computing power to operate the user interface including a display and keyboard, as well as to maintain communication with the edge network 204. Otherwise, essentially all processing of user data beyond user interaction is pushed or relocated from the user device to the virtual processing components including the VCPU 210, the VGPU 208 and the virtual storage 206. Processing of applications on the smartphone or other user device 202 is decentralized from the smartphone to the virtual processing components. The organization may expand or contract the available and assigned virtual processing components as required, such as by adding more CPU cores or designating a larger memory space. The user of each user device 202 may use an application on the user device 202 to select or specify virtual processing components or to add additional components such as additional virtual memory or additional CPU cores. Further, the user may use the application to release virtual processing components when they are no longer required.

Such an arrangement provides substantially improved efficiency over the conventional arrangement where each associate is provided with a very high-powered smartphone or tablet, with multi-core onboard CPU and very large size memory. Such devices are very expensive, and equipping a work group or team or class of students with such devices may be prohibitively expensive. In contrast, using the relatively low powered individual devices in combination with the shared virtual processing facilities and memory reduces the cost of the overall system and allows the flexibility of adjusting size and capacity on the fly with virtual elements. Moreover, for colleagues or teammates collaborating using the same data, working from a common data source and common applications accessed through the edge network may improve team efficiency as well. The users can enjoy the benefits of a handheld device such as a smartphone form factor but without the attendant cost and get the same processing power using the virtual facilities.

In some embodiments, user devices such as the user device 202 may have access to multiple edge network sites such as edge network 204. Through the multiple edge network sites, the user device 202 may access different platforms of different service providers or partners. The different platforms may provide different respective virtual processing facilities, each focused on one particular area. As an example, a first platform includes virtual processing facilities with many available virtual machines and best adapted to functions such operations as intensive computational workloads, computer aided design, etc. A second platform includes virtual processing facilities that are best adapted to machine learning or internet of things (IoT) services or high-performance computing. The virtual processing facilities may each include virtual storage, virtual CPUs, virtual GPUs and other hardware, as illustrated in FIG. 2A. In addition, the respective virtual processing facilities may include supporting software such as machine learning models or data analytics and visualization packages that are available to a user at the user device 202. The user may select the particular platform based on the service offerings available to users. Each platform may offer software functions and other features as a service to users and accessible through a network connection such as the edge network 204.

FIG. 2B is a block diagram illustrating an example, non-limiting embodiment of a system 230 functioning within the communication network of FIG. 1 in accordance with various aspects described herein. FIG. 2B illustrates interaction among an end user 232, a mobility network 234, and an edge server 236. In an example, embodiment, the end user 232 accesses the mobility network using a user device such as a cell phone, a smartphone, a tablet computer or a laptop computer, or any other suitable device. The mobility network 234 includes, in an example, a fifth generation (5G) cellular network providing radio communication services to users in areas served by base stations, also referred to as an eNodeB, eNB, gNodeB or gNB. The mobility network 234, in turn, is in communication with the edge server 236 for providing access to processing capabilities and data storage for the end user 232.

Initially, the process of interaction begins when the end user 232 launches a computationally intense application or other software program on the user device. In one example, the user is a gamer, and the user launches a computationally intense game on the user device. Computationally intense indicates that the game, application or other software program requires substantial processing power to operate and to render graphics, along with a large memory space to store data consumed by the game or generated by the game or application. The computationally intense game or application may use up so many resources of the user device that no or few other applications can run simultaneously or in the background of the user device, or that an error message is generated by the user device for the user indicating that the user device is overloaded. Other definitions of computationally intense applications or software may apply as well.

In accordance with various aspects described herein, the user device manages the computational requirements for the game by engaging remote computing resources including a virtual CPU, virtual GPU, or virtual storage as required. That is, rather than relying on a local processor and graphics card of the user device for processing data, the user will move those functions to a remote location, to be performed by virtual devices. Upon initiation of the game or the application, under control of the game or application, the user device sends a request to a remote gaming server to initiate the necessary computing.

The data of the user request is transmitted over the user's Internet or cellular connection to the mobility network 234. In embodiments, the quality of the network connection between the user 232 and the mobility network 234 is important for optimal functionality. For example, for some applications, the network connection should provide, at least as an option, a very low latency data transfer feature. For example, 5G cellular networks support ultra reliable low latency communications (URLLC) that provides a guaranteed quality of service (QOS) with extremely low latency, such as 1 ms. As indicated, in addition to or instead of accessing the mobility network 234, the user may, via the user device, access a broadband network such as broadband access 110 (FIG. 1). The broadband network may be operated by the same network operator as the mobility network 234 or by a different network operator.

After transmission from the user device, the data forming the user request then reaches a cell site, base station, eNodeB or gNodeB of the mobility network 234. The base station is responsible for two-way communication between the mobility network and the user device. In the event the user is mobile, communication with the user device may be handed off from a first base station to other base stations to maintain the connection with the user equipment. This enables the user to begin a project or game that requires high-powered computing in one location and move to other locations while continuing work on the project or game. Other network features such as bandwidth aggregation may be applied to enhance the speed and reliability of the connection between the network and the user device. Similarly, the 5G cellular network may use features such as network slicing to support low latency communications with the user device.

Within the mobility network 234, instead of sending the data forming the user request to a central cloud server potentially located hundreds or thousands of miles away, the base station sends the user data to the edge server 236 installed nearby. Data transfer between the user device and user 232 and the edge server 236 preferably occurs at a rate fast enough to justify use by the user 232 of the product and service provided by the edge server 236.

The edge server 236 in this example is equipped with a virtual CPU and virtual GPU that can perform the necessary computations for the game or other application. This could be anything from rendering graphics to processing machine learning (ML) models or artificial intelligence (AI) algorithms, depending on the requirements of the user and the game or other application. The edge server 236 may contact a remote server operated by a provider of the game or application to begin receiving data related to game play or the application.

Once the computations are done at the edge server 236, the results are sent back to the user 232 and the user device through the base station of the mobility network 234. This completes the round trip of the data between the user 232 and the edge server 236.

Many benefits are afforded by an arrangement as exemplified by FIG. 2B. The primary consumer benefits for the user 232 of this setup are lower latency, less jitter, and potentially faster ping times. This can improve the gaming experience, for example, by making games more responsive and reducing lag. Other types of applications and data processing uses see similar benefits. For the network operator associated with the mobility network 234 (or broadband network), edge computing can reduce the amount of data that needs to be transmitted to and from the central cloud servers, which can reduce bandwidth usage and potentially lower costs. Edge computing can also allow the company to offer new, latency-sensitive services.

FIG. 2C is a block diagram illustrating an example, non-limiting embodiment of a conventional system 240 for processing traffic between an end user and a remote application. FIG. 2C illustrates interaction between a user device 242, an access network 244, a core network 246 and an application server or content server, referred to as remote server 248.

The user device 242 may be any suitable user device such as a cell phone, smartphone, tablet computer or laptop computer. The access network 244 may include a cellular network such as a 5G cellular network. The access network provides wireless or wireline access for the user device 242 to the network equipment of the network operator. The 5G cellular network further includes a core network such as core network 246. The core network is in data communication with the user device 242 through the access network 244 and provides functions such as mobility management and accounting and authorization of devices such as the user device 242. The remote server 248 is generally operated by a third party who provides access to applications such as gaming applications, content such as streaming audio and video files, or any other information of interest to the user of the user device 242.

In an example, the user of the user device 242 initiates access to a game or other application. For example, the user accesses cloud gaming through a commercially available server, forming remote server 248, which provides the GPU performance portion of the user's view on the user device 242.

The user device 242 connects to a gNodeB or other equipment of the access network 244. The access network 244 includes features of a radio access network (RAN), for example, for prioritizing user traffic on the access network. One prioritization feature is a selectable quality of service (QOS). The QoS is a value associated with the traffic from the user that controls relative prioritization of the traffic from the user device. For example, communication associated with first providers and other emergency personnel may be assigned a highest priority. Other users or applications are assigned other priorities.

Traffic from the user device is then conveyed from the access network 244 to the core network 246. The core network 246 applies one or more network policies. Network policies are rules that are used for traffic handling decisions in real-time and that govern the behavior of devices, users, and applications in the network mobility. Network policies represent the network programmability options to define how the network should behave and how the connectivity service should be delivered based on a set of pre-defined conditions applicable to the end-user and to the network. The network policies, for example, control communication for the user device 242 according to the cell phone plan maintained by the user of the user device 242 with the service provider.

User communications are routed from the core network through a gateway to the public internet. By means of the public internet, the remote server 248 is accessed and the user may interact with a gaming application or other application, or content located at the remote server 258. The communication from the user device 242, over the radio network of the access network 244, through facilities of the core network 246 to the remote server 248, and back again, is maintained as long as the user engages with the content on the remote server 248.

FIG. 2D is a block diagram illustrating an example, non-limiting embodiment of a conventional system 250 for processing traffic between an end user and a remote application. FIG. 2D illustrates interaction between a user device 252, an access network 254, a core network 256 and an application server or content server, referred to as remote server 258. In the example of FIG. 2D, exemplary geographical associations are made to illustrate network processing.

In the example of FIG. 2D, the user is performing similar operations as illustrated in FIG. 2C. The user associated with user device 252 is located in Dallas and connects with the access network 254, also located in Dallas. The user device 252 accesses the access network 254 based on QoS or another prioritization. The access network 254 is in communication with the core network 256 located in Plano. For example, Plano is approximately 20 miles from Dallas. The core network 256 may provide core services for many access networks similar to the access network 254 but serving different geographic areas. The core network 256 applies network policies to control traffic including user traffic for the user device 252.

In the example of FIG. 2D, the internet is hosted at servers 257 located in Houston. The core network 256 includes a gateway to the internet which conveys user data to the servers 257 in Houston. Houston is located approximately 250 miles from Plano. The servers 257 in Houston provide access over the public internet to the remote server 258 in Atlanta. Atlanta is located approximately 800 miles from Houston and approximately 825 miles from Dallas. The user associated with the user device 252 may interact with a gaming application or other application or content located at the remote server 258.

In a network arrangement such as is illustrated in FIG. 2D, expected latency for the user device 252 in Dallas accessing the remote server 258 in Atlanta is approximately 35 to 100 ms. The latency is affected by the quality of the network segments between the endpoints and the geographic distance between the endpoints.

FIG. 2E is a block diagram illustrating an example, non-limiting embodiment of a system 260 functioning within the communication network of FIG. 1 in accordance with various aspects described herein. FIG. 2E illustrates interaction between a user device 262, an access network 264, a core network 266 and an application server or content server, referred to as remote server 258. In the example of FIG. 2E, exemplary geographical associations similar to those of FIG. 2D are made to illustrate network processing.

In FIG. 2E, the user associated with the user device 262 seeks to access cloud gaming from an exemplary location in Dallas. The user device 262 attaches to the access network 264 through a base station or gNodeB in Dallas. The network applies appropriate prioritization such as QoS to the user data of the user device 262. The base station is in communication with core network 266 in Plano. The core network 266 provides core network services and internet access for the access network 264 and devices attached to the access network. The core network 266 applies appropriate network policies to the user data.

In the embodiment of FIG. 2E, the core network 266 includes or is in data communication with an edge server 266a. The edge server 266a communicates with the internet server 267 in Houston. The edge server 266a includes suitable data processing and memory storage capabilities to permit decentralization of processing and data storage on the user device 262 to the edge server 266a. The edge server 266a may include virtual GPU devices and virtual VPU devices and virtual storage that may be modified on demand to meet user requirements, substantially in real time.

Further, the processing at the edge server 266a is brought physically closer to the user and user device 262. In this example, the gaming application runs on the edge server 266a in Plano, at the core network 266, rather than remotely in Houston. Thus, the exemplary embodiment of FIG. 2E operates to substantially reduce or minimize the overall distance that data must travel between the location where processing occurs and the user, from Atlanta to Plano (located adjacent to Dallas). Moreover, overall latency is reduced to a range of 2 to 5 ms, up to 20 ms maximum, for example. Other metrics important to gaming applications, such as jitter and packet loss, are substantially reduced as well. Thus, a system in accordance with various aspects described herein provides substantial improvements in processing speed and reliability relative to the conventional systems.

In some embodiments, the functionality of the system 260 may be presented to users as a service. The service may include access to virtual CPU, virtual GPU and virtual storage facilities. These facilities may be offered by the network operator, i.e., the same network operator that operates the mobility network or the broadband network to which the user subscribes. The service may be included as part of the user's subscription to services or offered as a standalone service. Different tiers of service may be offered for different prices, with more expensive tiers providing access to higher speed, lower latency or other service features.

In examples, the user may access an application on a smartphone or other device. The application may provide a user interface to allow the user to select, for example, the number of VCPUs and VGPUs required by the user to complete a task. Alternatively, a default number of devices may be provided, such as based on the product tier, or the number of devices provided may be automatically selected by the application. The application on the user device may cooperate with a server location at the core network 266 to select and deploy virtual processing units and virtual storage for use by the user.

In some examples, the network operator may partner with third-party providers to obtain access to processing facilities of the third-party providers for use by the users. This arrangement could be the subject of a service agreement between the network operator and the third-party providers. Once the user selects or is assigned a number of processors or other supplemental processing facilities, the network operator may then inform the third-party providers. Once the number of VCPU/VGPU have been allocated, the user will have access to higher processing speeds for the user's respective tasks.

Further, as part of the software and hardware integration, smartphone users may use the network operator's edge network to also access decentralized storage options on a periodic basis, such as monthly. This enables the user to offload data storage to the facilities of the network operator.

In some examples, the user devices may be reduced in size and complexity and reconfigured to make use of the supplemental processing facilities available at the edge server 266a of the network operator. For example, a compatible device may include a communication front end for wireless and wireline communication by the user device, a battery or other depletable energy source to power the user device, a user interface including a display and keyboard, a mini-CPU with reduced processing capabilities and mini-storage. The reduced storage may be just large enough to store the operating system. All other features may be slimmed down or eliminated. This design allows many features to be moved off the user device, including large scale storage (i.e., storage greater than 1 TB), a large capacity CPU and a large capacity GPU. As indicated, these features may be accessed over a low latency connection to network equipment.

The ability to offload or decentralize processing functions in this manner allows new types of user devices to be developed, such as different screen formats, different battery sizes, and other variations. Omitting high-power processors and memory allows battery sized to be reduced and allows reduction in heat generation. Thus, different form factors may be specified for the user device and different materials may be used for the user device.

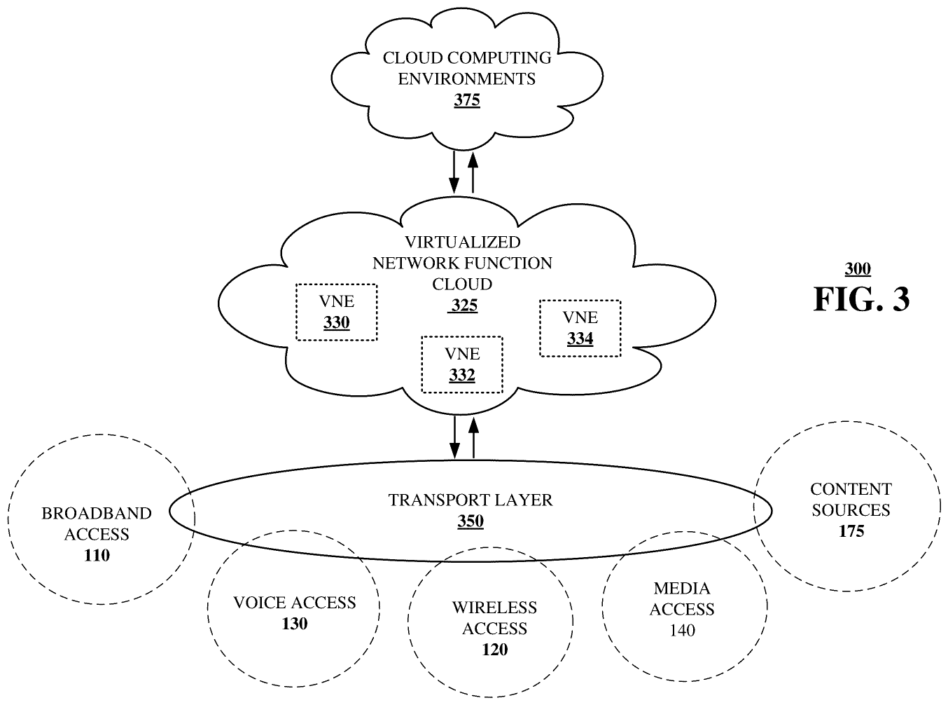

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of system 200, system 230, and system 260 presented in FIG. 1, FIG. 2A, FIG. 2B, FIG. 2E, and FIG. 3. For example, virtualized communication network 300 can facilitate in whole or in part decentralizing data processing from a user device, which accesses a remote application such as a video game or artificial intelligence process, to virtual processing components such as VGPUs, VCPUs and virtual storage, accessed over low latency networks such as the virtualized communication network.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part decentralizing data processing of remote applications such as video games and artificial intelligence processes that process large amounts of data. The data processing of such application data can be shifted from a user device such as a smartphone to virtual devices accessed over a low latency network to improve performance and user experience at the user device.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

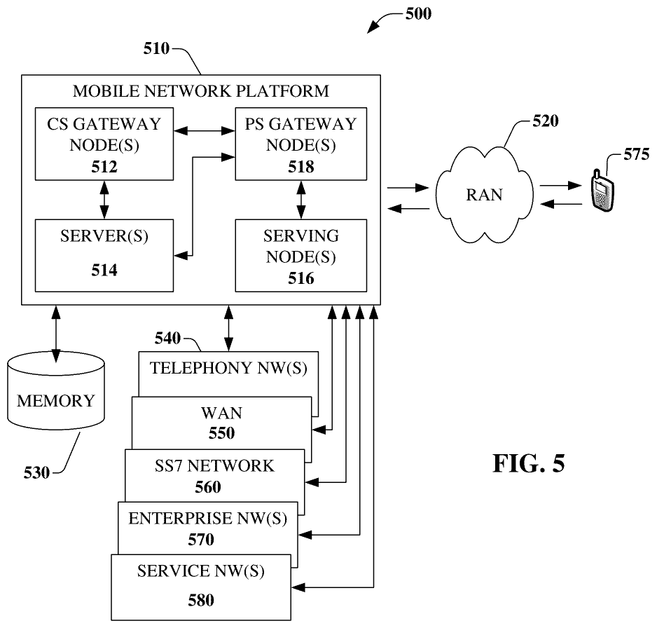

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part decentralizing data processing from a user device accessing the mobile network platform 510 to virtual processing components at an edge network to improve performance and user experience at the user device. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part interacting at the communication device 600 with a remote application such as a video game, wherein the data of the video game is processed on a virtual CPU, virtual GPU and virtual storage to decentralize operation from processing on the communication device and obtain a better user experience for the user of the communication device 600.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A smartphone, comprising:
a communication circuit configured for wireless communication with a mobility network;
a processing system including a processor; and
a memory that stores executable instructions that, when executed by the processing system, facilitate performance of operations, the operations comprising:
requesting access over the mobility network to a remote application; and
cooperatively processing data of the remote application with virtual processing components, wherein the virtual processing components are remotely located from the smartphone and are assigned to the smartphone for processing the data of the remote application.

2. The smartphone of claim 1, wherein the cooperatively processing the data of the remote application with the virtual processing components comprises:
interacting, over the mobility network, by the processing system of the smartphone, with one or more virtual graphics processing units, one or more virtual central processing units or virtual storage, or a combination of these, located at an edge network of the mobility network.

3. The smartphone of claim 2, wherein the operations further comprise:
accessing the edge network over a low latency connection of the mobility network to enable near real-time interaction at the smartphone with the remote application.

4. The smartphone of claim 3, wherein the requesting access over the mobility network to the remote application comprises:
initiating game play on a video game at the smartphone.

5. The smartphone of claim 3, wherein the requesting access to the remote application comprises:
participating in a virtual reality (VR) environment at the smartphone.

6. The smartphone of claim 1, wherein the operations further comprise:
receiving, from a user of the smartphone interacting with a user interface of the smartphone, request information indicating a requested number of virtual graphics processing units, a requested number of virtual central processing units, or a requested amount of virtual storage, or a combination of these; and
communicating the request information over the mobility network;
receiving, over the mobility network, confirmation of an assignment of the requested number of virtual graphics processing units, the requested number of virtual central processing units, or the requested amount of virtual storage; and
communicating, to the user via the user interface of the smartphone, information about the confirmation.

7. The smartphone of claim 1, wherein the cooperatively processing the data of the remote application with the virtual processing components comprises:
interacting, over the mobility network, with one or more virtual graphics processing units, one or more virtual central processing units or virtual storage, or a combination of these, provided by a third-party as a service.

8. The smartphone of claim 7, wherein the operations further comprise:
interacting with second virtual processing components, the second virtual components including one or more second virtual graphics processing units, one or more second virtual central processing units or second virtual storage, or a combination of these, wherein the second virtual processing components are provided by a second third-party as a second service.

9. The smartphone of claim 8, wherein the operations further comprise:
receiving, from the user of the smartphone, a selection of one of the virtual processing components and the second virtual processing components, wherein the selection is based on requirements of the remote application.

10. The smartphone of claim 1, wherein the operations further comprise:
decentralizing processing of data of the remote application from the processing system of the smartphone to the virtual processing components to improve processing speed of the data of the remote application for a user of the smartphone.

11. A machine-readable medium, comprising executable instructions that, when executed by a processing system including a processor, facilitate performance of operations, the operations comprising:
communicating, by a user device, with a mobility network operated by a network operator;
requesting, over the mobility network, access to a remote application;
communicating, over the mobility network, with an edge network of the network operator; and
interacting, over the mobility network with the remote application, wherein the interacting with the remote application comprises interacting with a virtual graphics processing unit, a virtual processing unit, or virtual storage, or a combination of these, which have been temporarily established at the edge network to enable decentralized processing of data of the remote application.

12. The machine-readable medium of claim 11, wherein the operations further comprise:
accessing the edge network over a low latency connection of the mobility network to enable near real-time interaction at the user device with the remote application.

13. The machine-readable medium of claim 11, wherein the interacting with the remote application comprises:
playing a game on a user interface of the user device while game data of the game is processed on the virtual graphics processing unit, the virtual processing unit, or the virtual storage.

14. The machine-readable medium of claim 11, wherein the interacting with the remote application comprises:
accessing a machine learning model on a user interface of the user device while data of the machine learning model is processed on the virtual graphics processing unit, the virtual processing unit, or the virtual storage.

15. The machine-readable medium of claim 11, wherein the operations further comprise:
receiving, at a user interface of the user device, user commands to initiate a third-party service;
communicating, over the mobility network, the request to access the remote application through the third-party service; and
communicating data over the mobility network with the virtual graphics processing unit, the virtual processing unit, or the virtual storage provided by the third-party service, to interact with the remote application.

16. A method, comprising:
communicating, by a communication interface of a handheld user device, with a mobility network of a network operator;
requesting, by a processing system of the user device, the processing system including a processor, access to a remote application located at a remote server; and
communicating, by the processing system, over the mobility network with an edge network of the network operator, wherein the edge network accesses virtual processing components to process data of the remote application at the virtual processing components, wherein the virtual processing components are located geographically close to the edge network of the network operator to enable decentralizing of access to the remote application from the processing system of the handheld user device to the virtual processing components to improve user experience with the remote application at the handheld user device.

17. The method of claim 16, comprising:
accessing, by the communication interface, a low latency connection of the mobility network to enable near real-time interaction at the handheld user device with the remote application.

18. The method of claim 16, comprising:
accessing, by the communication interface, a core network of the network operator, wherein the virtual processing components are instantiated at the core network of the network operator as one or more virtual central processing units, one or more graphics processing units, virtual storage, or a combination of these.

19. The method of claim 16, comprising:
accessing, by the communication interface, a core network of the network operator, wherein the virtual processing components are instantiated at a network location of a third-party service provider as one or more virtual central processing units, one or more graphics processing units, virtual storage, or a combination of these, and accessed through the core network of the network operator.

20. The method of claim 16, wherein the requesting access to a remote application comprises:
requesting, by the processing system, access to a video game,
and further comprising processing video graphics data of the video game at the virtual processing components rather than the processing system of the user device to improve the user experience with the video game.
